(19) United States
(12) Patent Application Publication
(10) Pub. No.: US 2024/0228698 A1
(43) Pub. Date: Jul. 11, 2024

(54) RENEWABLE AND SUSTAINABLE PROCESS FOR EXTRACTION OF PHA FROM MICROBIAL BIOMASS

(71) Applicant: Newlight Technologies, Inc., Huntington Beach, CA (US)

(72) Inventors: Anna Coragliotti, Long Beach, CA (US); Garret Sell, Seal Beach, CA (US); Mike Giardello, Pasadena, CA (US); Kenton Kimmel, Dana Point, CA (US)

(21) Appl. No.: 18/526,814

(22) Filed: Dec. 1, 2023

Related U.S. Application Data
(60) Provisional application No. 63/476,865, filed on Dec. 22, 2022.

(51) Int. Cl. C08G 63/81; B01D 21/26; B01D 37/00; B01D 39/20

(52) U.S. Cl. CPC C08G 63/81; B01D 21/262; B01D 37/00; B01D 39/2055

(57) ABSTRACT

The present disclosure generally relates to embodiments for the renewable and sustainable process of recovering PHA from microbial biomass. Several embodiments relate to systems and individual devices or groups of devices to accomplish efficient PHA recovery from microbial biomass. Some embodiments further relate to processes for recycling certain reagents or materials used in the process for subsequent re-use in processing additional microbial biomass to recover PHA.

### BACKGROUND

The embodiments described herein generally relate to an improved process for the production and processing of polyhydroxyalkanoates, and specifically to a renewable process for the extraction of polyhydroxyalkanoates from microbial biomass.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Polyhydroxyalkanoates (PHAs) are polymers that serve as energy storage vehicles in microorganisms. PHAs are biodegradable in both aerobic and anaerobic conditions, are biocompatible with mammalian tissues, and can be used as alternatives to fossil fuel-based plastics such as polypropylene, polyethylene, and polystyrene. In comparison to petrochemical-based plastics, which are neither biodegradable nor made from sustainable sources of carbon, PHAs afford significant environmental benefits.

The utilization of food crop derived sugars in genetically engineered microorganism-based aqueous fermentation systems is often regarded as the most efficient and economical platform for PHA production. Specifically, sugar-based PHA production processes are capable of generating high density fermentation cultures and high PHA inclusion concentrations, and, by maximizing the cell culture density and PHA inclusion concentration therein, it is believed that carbon, chemical, and energy efficiencies are also maximized. For example, comparing a low cell and PHA concentration process to a high cell and PHA concentration process, a low concentration process requires significantly more, per given unit of PHA-containing biomass) energy for dewatering cells prior to PHA extraction treatment, ii) liquid culture volume, and associated chemicals, mixing energy, and heat removal energy, and iii) both energy and chemicals for separating PHA from biomass. Accordingly, whereas the sugar-based genetically-engineered microorganism PHA process yields maximized cell densities and PHA concentrations relative to low concentration processes, it is also regarded as the most carbon, chemical, energy, and, thus, cost efficient PHA production method.

Unfortunately, despite these maximized efficiency advantages, sugar-based PHA production remains many times more expensive than fossil fuel-based plastics production. Thus, given the apparent efficiency maximization of the high density sugar-derived PHA production process, PHAs are widely considered to be fundamentally unable to compete with fossil fuel-based plastics on energy, chemical, and cost efficiency.

In some embodiments, a renewable and sustainable process for extraction of PHA from microbial biomass is disclosed. In some embodiments, the biomass is derived from methanotrophic microorganisms. In some embodiments, the process comprises delivering PHA containing biomass to a dissolution vessel; contacting said PHA biomass with external solvent; substantially isolating the PHA-rich solvent from the PHA-reduced biomass; precipitating PHA contained in the PHA-rich solvent; isolating precipitated PHA from the PHA-rich solvent; drying the isolated PHA; and processing the isolated PHA.

In some embodiments, the PHA comprises one or more PHA polymers selected from Polyhydroxyalkanoate (PHA), polyhydroxybutyrate (PHB), polyhydroxyvalerate (PHV), polyhydroxybutyrate-covalerate (PHB/V), polyhydroxyhexanoate (PHHx), short chain length (SCL) PHA, medium chain length (MCL) PHA, and long chain length (LCL) PHA.

In some embodiments, the external solvent is a halogenated solvent. In some embodiments, the external solvent is a non-halogenated solvent. In some embodiments the solvent comprises one or more of Butyl acetate, isobutyl acetate, ethyl lactate, isoamyl acetate, benzyl acetate, 2-methoxy ethyl acetate, tetrahydrofurfuryl acetate, propyl propionate, butyl propionate, pentyl propionate, butyl butyrate, isobutyl isobutyrate, ethyl butyrate, ethyl valerate, methyl valerate, benzyl benzoate, methyl benzoate, dimethyl succinate, dimethyl glutarate, dimethyl adipate, isobutyl alcohol, 1-butanol, 2-methyl-1-butanol, 3-methyl-1 butanol, 1-pentanol, 3-pentanol, amyl alcohol, allyl alcohol, hexanol, heptanol, octanol, cyclohexanol, 2-ethylhexanol, tetrahydrofurfuryl alcohol, furfuryl alcohol, benzyl alcohol, 2-furaldehyde, methyl isobutyl ketone, methyl ethyl ketone, g-butyrolactone, methyl n-amyl ketone, 5-methyl-2-hexanone, ethyl benzene, 1,3-dimethoxybenzene, cumene, benzaldehyde, 1,2-propanediol, 1,2-diaminopropane, ethylene glycol diethyl ether, 1,2,3-trimethylbenzene, 1,2,4-trimethylbenzene, 1,3-dioxane, 1,4-dioxane, 1-nitropropane, toluene-2,4-diisocyanate, acetic acid, acrylic acid, acetic anhydride, alpha-methylstyrene, acetophenone, toluene, ethylene glycol diacetate, dimethyl sulfoxide, dimethyl acetamide, dimethyl formamide and propylene carbonate. In some embodiments, the solvent is naturally or artificially produced. In some embodiments, the solvent is heated.

In some embodiments, the process further comprises separation of the PHA-reduced biomass from the solvent-rich PHA by centrifugation and/or filtration. In some embodiments, desolventization of the PHA-lean solvent comprises washing the PHA-lean solvent with an external wash solvent, the external wash solvent comprises one or more of water, ethanol, methanol, acetone. In some embodiments, the external wash solvent is naturally produced. In some embodiments, the external wash solvent is renewably produced. In some embodiments, the external wash solvent is environmentally non-aggressive. In some embodiments, the external wash solvent is non-toxic. In some embodiments, the process further comprises collecting external wash solvent for filtering, reuse, and/or disposal. recycling PHA-lean solvent following desolventization. In some embodiments, recycling PHA-lean solvent following desolventization comprises filtration. In some embodiments, the filter is an activated carbon filter. In some embodiments, the process further comprises returning the clean external solvent to an external solvent storage tank. In some embodiments, the process comprises returning the clean external solvent to the dissolution vessel. In some embodiments, the process further comprises returning the clean external solvent to the precipitation vessel.

In some embodiments, dissolution of PHA and PHA containing biomass comprises subjecting the PHA and PHA containing biomass to relatively higher temperatures. In some embodiments, dissolution of PHA and PHA containing biomass comprises agitation of the PHA solvent and PHA containing biomass. In some embodiments, the agitation of the PHA solvent and PHA containing biomass is low shear agitation. In some embodiments, dissolution of PHA and PHA containing biomass occurs over time. In some embodiments, dissolution of the PHA and PHA containing biomass occurs over 0-5 hours, 1 hour, 2 hours, 3 hours, 4 hours, 5 hours. In some embodiments, the dissolution vessel comprises an internal filter. In some embodiments, the internal filter is a Nutsche style filter. In some embodiments, the filter comprises pore sizes of up to 200 μm, 190 μm, 180 μm, 170 μm, 160 μm, 150 μm, 150-100 μm, 100-50 μm, 50-20 μm, 20-15 μm, 15-10 μm, 5-10 μm, 1-5 μm, 1-0.001 μm, and overlapping ranges thereof.

In some embodiments, the PHA-reduced biomass comprises less than 10%, 9%, 8%, 7%, 6%, 5%, 4%, 3%, 2%, 1%, 0.1% PHA.

In some embodiments, the process further comprises drying of the separated PHA-reduced biomass. In some embodiments, the PHA-reduced biomass is dried by vacuum, evaporative-type dryer, oven dryer, rotary dryer, spin flash dryer, spray dryer convection heat dryer, tray dryer, scrape-flash dryer, or other dryer type. In some embodiments, residual solvent vapor released from the PHA-reduced biomass during drying is trapped. In some embodiments, the trapped solvent vapor is filtered. In some embodiments, the filter comprises an activated carbon filter.

In some embodiments, the dried PHA-reduced biomass is re-fed into the system for further extraction of PHA. In some embodiments, the process further comprises returning the clean external solvent to an external solvent storage tank. In some embodiments, the process further comprises returning the clean external solvent to the dissolution vessel. In some embodiments, the process further comprises returning the clean external solvent to the precipitation vessel.

In some embodiments, the process further comprises milling and/or pelleting of the dried PHA-reduced biomass.

In some embodiments, precipitation of PHA and desolventization of PHA occur in the same vessel. In some embodiments, precipitation of PHA and desolventization of PHA occur in different vessels. In some embodiments, precipitation occurs by cooling of the PHA-rich solvent at a specific rate. In some embodiments, the cooling rate of the PHA-rich solvent is chosen specifically for the ability of PHA to precipitate crystals of a desired size.

In some embodiments, the process further comprises drying the substantially isolated PHA. In some embodiments, the substantially isolated PHA is dried by vacuum, evaporative-type dryer, oven dryer, rotary dryer, spin flash dryer, spray dryer convection heat dryer, tray dryer, scrape-flash dryer, or other dryer type. In some embodiments, the process comprises trapping residual solvent released during drying of the substantially isolated PHA. In some embodiments, the trapped solvent vapor is filtered. In some embodiments, the filter comprises an activated carbon filter. In some embodiments, the process further comprises returning the clean external solvent to an external solvent storage tank. In some embodiments, the process further comprises returning the clean external solvent to the dissolution vessel. In some embodiments, the process further comprises returning the clean external solvent to the precipitation vessel.

In some embodiments, the process further comprises milling and/or pelleting of the isolated PHA.

### BRIEF DESCRIPTION OF THE DRAWINGS

The drawings are provided to illustrate representative embodiments and are not intended to limit the scope of the disclosure. A better understanding of the systems and methods described herein will be appreciated upon reference to the following description in conjunction with the accompanying drawings, wherein:

FIG. 1 illustrates a flowchart of a non-limiting example process for solvent extraction of PHA from biomass.

FIG. 2 is a schematic diagram of a non-limiting example system useful for renewable solvent extraction of PHA from biomass.

FIG. 3A is an illustrative representation of solvent dissolved PHA polymer prior to precipitation.

FIG. 3B is an illustrative representation of precipitated PHA cake recovered from solution after cooling and filtration.

FIG. 3C is an illustrative example of PHA recovery from suspension in solvent as a function of time and temperature.

FIG. 4 is an illustrative representation of non-limiting embodiments of the process disclosed herein.

FIG. 5 is a representative example of the means utilized in the disclosed process capable of PHA extraction from biomass and recovery, filtration, and storage of used solvent.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the presently disclosed invention is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

While PHAs have significant environmental advantages compared to fossil fuel-based plastics, the cost of PHA production is generally viewed as a significant limitation to the industrial production and commercial adoption of PHAs. As used herein, the terms “PHA”, “PHAs”, and “polyhydroxyalkanoate”, shall be given their ordinary and customary meaning, including, among other things, polymers generated by microorganisms as energy and/or carbon storage vehicles; biodegradable and biocompatible polymers that can be used as alternatives to petrochemical-based plastics such as polypropylene, polyethylene, and polystyrene; and/or polymers produced by bacterial fermentation of sugars, lipids, or gases. PHAs include, but are not limited to, polyhydroxybutyrate (PHB), polyhydroxyvalerate (PHV), polyhydroxybutyrate-covalerate (PHB/V), and polyhydroxyhexanoate (PHHx), as well as both short chain length (SCL), medium chain length (MCL), and long chain length (LCL) PHAs.

Generally, the overall cost of PHA production is determined by three major inputs: 1) carbon, 2) chemicals, and 3) energy. Accordingly, efforts to reduce the cost of PHA production must address one or more of these areas, specifically by: i) reducing carbon input costs, ii) increasing carbon-to-PHA yields, iii) reducing the volume of chemicals required for PHA production, and/or iv) increasing energy-to-PHA yields.

Current processes for extraction of PHA from microbial biomass, such as aqueous extraction or solvent extraction, require large volumes of water and solvents, each having their own attendant problems and costs associated with their acquisition, handling, and disposal.

Some embodiments herein are directed to a process for renewable and sustainable extraction of PHA from microbial biomass. As discussed above, currently, processes of PHA extraction require large amounts of chemicals, greatly contributing to the cost of PHA production. However, the embodiments herein provide processes and systems for extraction of PHA from microbial biomass, without the same attendant difficulties and costs associated with current processes of PHA extraction. According to some embodiments, the steps of this process are as follows: (a) providing PHA-containing microbial biomass; (b) dissolving a portion of the PHA-containing biomass from the culture; (c) extracting PHA from the PHA-containing biomass; (d) purifying the isolated PHA; (c) and drying the isolated PHA; (f) trapping and filtering used solvent; and (g) returning clean-solvent to the system for storage and/or reuse. Each of the above recited steps in the process are discussed in more detail below.

### Providing PHA Containing Biomass

The terms “biomass” and “biomass material” have their ordinary meaning, including, but not be limited to, microorganism-derived material, including intracellular, cellular, and/or extracellular material, such materials including, but not limited to, a polymer or polymers, amino acids, nucleic acids, carbohydrates, lipids, sugars, PHA, volatile fatty acids, chemicals, gases, such as carbon dioxide, methane, volatile organic acids, and oxygen, and/or metabolic derivatives, intermediaries, and/or end-products. In several embodiments, biomass is dried or substantially dried.

In some embodiments, the biomass contains less than about 99% water. In other embodiments, the biomass contains between about 99% to about 75% water, including about 95%, 90%, 85%, and 80%. In some embodiments, the biomass contains between about 75% and about 25% water, including 75%-65%, 65%-55%, 55%-45%, 45%-35%, 35%-25%, and overlapping ranges thereof. In additional embodiments, the biomass contains from about 25% water to less than about 0.1% water, including 25%-20%, 20%-15%, 15%-10%, 10%-5%, 5%-1%, 1%-0.1%, and overlapping ranges thereof. In still other embodiments, the biomass contains no detectable amount of water. Depending on the embodiment, water is removed from the biomass by one or more of freeze drying, spray drying, fluid bed drying, ribbon drying, flocculation, pressing, filtration, and/or centrifugation. In some embodiments, the biomass may be mixed with one or more chemicals, such as methylene chloride, acetone, methanol, and/or ethanol, at various concentrations. In other embodiments, the biomass may be processed through homogenization, heat treatment, pH treatment, enzyme treatment, solvent treatment, spray drying, freeze drying, sonication, or microwave treatment.

The term “PHA-lean biomass” has its ordinary and customary meaning, including, among other things, any biomass wherein at least a portion of PHA has been removed from the biomass through a PHA extraction process. The term “PHA-containing biomass” also has its ordinary and customary meaning, including, among other things, any biomass wherein at least a portion of the biomass is PHA.

Extracting the PHA from the PHA-Containing Biomass

The terms “extraction” and “PHA extraction” have their ordinary and customary meaning, and may be used interchangeably to describe the removal and/or separation of PHA from biomass. PHAs may be extracted from biomass by several processes, including, among other things, the use of chemicals, mechanical means, solvents, and enzymes. These processes include the use of: i) solvents, such as acetone, ethanol, methanol, methylene chloride, and dichlorocthane, with and/or without the application of pressure and/or elevated temperatures, ii) supercritical carbon dioxide, iii) enzymes, such as protease, iv) surfactants, v) pH adjustment, including the protonic or hydroxide-based dissolution of non-PHA biomass, and/or vi) hypochlorite to dissolve non-PHA biomass, including the use of hypochlorite in conjunction with a solvent, such as methylene chloride. In some embodiments, PHA is extracted by solvent extraction from a PHA-containing biomass comprising gas-utilizing microorganisms and/or biomass-utilizing microorganisms to produce isolated PHA and PHA-reduced biomass. In some solvent-based embodiments, solvents suitable for dissolving the PHA are used, including carbon dioxide, acetone, methylene chloride, chloroform, water, ethanol, and methanol. In some embodiments, particular ratios of solvent to PHA provide optimal dissolution of PHA from the culture, and therefore lead to improved extraction and isolation efficiency and yield. For example, in some embodiments, ratios of solvent to PHA (in grams) of about 500:1 are used. In some embodiments, ratios of about 0.01:1 are used. In some embodiments, ratios ranging from between about 500:1 and 0.01:1 are used, such as 0.05:1, 1.0:1, 1.5:1, 20:1, 250:1, 300:1, 350:1, 400:1, or 450:1.

In some embodiments the solvents will be renewably produced by a microbial source. In some embodiments the solvents include Butyl acetate, isobutyl acetate, ethyl lactate, isoamyl acetate, benzyl acetate, 2-methoxy ethyl acetate, tetrahydrofurfuryl acetate, propyl propionate, butyl propionate, pentyl propionate, butyl butyrate, isobutyl isobutyrate, ethyl butyrate, ethyl valerate, methyl valerate, benzyl benzoate, methyl benzoate, dimethyl succinate, dimethyl glutarate, dimethyl adipate, isobutyl alcohol, 1-butanol, 2-methyl-1-butanol, 3-methyl-1 butanol, 1-pentanol, 3-pentanol, amyl alcohol, allyl alcohol, hexanol, heptanol, octanol, cyclohexanol, 2-ethylhexanol, tetrahydrofurfuryl alcohol, furfuryl alcohol, benzyl alcohol, 2-furaldehyde, methyl isobutyl ketone, methyl ethyl ketone, g-butyrolactone, methyl n-amyl ketone, 5-methyl-2-hexanone, ethyl benzene, 1,3-dimethoxybenzene, cumene, benzaldehyde, 1,2-propanediol, 1,2-diaminopropane, ethylene glycol diethyl ether, 1,2,3-trimethylbenzene, 1,2,4-trimethylbenzene, 1,3-dioxane, 1,4-dioxane, 1-nitropropane, toluene-2,4-diisocyanate, acetic acid, acrylic acid, acetic anhydride, alpha-methylstyrene, acetophenone, toluene, ethylene glycol diacetate, dimethyl sulfoxide, dimethyl acetamide, dimethyl formamide and propylene carbonate.

As discussed above, changes in temperature and/or pressure may also be used to facilitate the extraction of PHA from the PHA-containing biomass. In some embodiments, the extraction solvent chosen dictates the limits of temperature, pressure, and/or incubation times that are used. In some embodiments, solvent is combined with PHA-containing biomass and incubated for several minutes up to several hours. For example, in some embodiments, incubation is for about 10 minutes, while in other embodiments, overnight incubation times are used. In some embodiments, incubation times range from 30 minutes to about 1 hour, about 1 hour to about 2 hours, about 2 hours to about 4 hours, about 4 hours to about 6 hours, about 6 hours to about 8 hours, about 8 hours to about 10 hours, and from about 10 hours to overnight. Choice of incubation time is determined by solvent, culture density (e.g., number of microorganisms), type of organisms, expected PHA yield, and other similar factors.

Incubation temperature is also tailored to the characteristics of a given culture. Incubation temperatures can range from below room temperature to elevated temperatures of up to about 150° C. or about 200° C. For example, depending on the solvent and other variables of the culture, temperatures are used that range from about 10° C. to 25° C., from about 25° C. to about 40° C., from about 40° C. to about 55° C., from about 55° C. to about 60ºC, from about 60° C. to about 75ºC, from about 75° C. to about 90° C., from about 90° C. to about 105° C., from about 105° C. to about 120° C., from about 120° C. to about 135° C., from about 135° C. to about 150° C., from about 150° C. to about 200° C., and overlapping ranges thereof.

As can be appreciated, if changes in temperature are made to a culture in a closed vessel, changes in pressure result. In some embodiments, increased pressure provides a shearing effect that aids in the liberation of PHA from the microorganisms. In some embodiments, pressure is regulated within a particular range. For example, in some embodiments, pressure of the reaction of the PHA-containing biomass with solvent occurs between about 40 and 200 psi, including about 50 to 60 psi, 60 to 70 psi, 70 to 80 psi, 80 to 90 psi, 90 to 100 psi, 100 to 125 psi, 125 to 150 psi, 150 to 175 psi, 175 to 200 psi and overlapping ranges thereof. Additional sources of shear (e.g., agitation, pumping, stirring etc.) are optionally used in some embodiments to enhance the extraction of PHA. Any one, or combination, of the PHA extraction methods described herein, or disclosed in the art, may be utilized as a method to carry out PHA extraction and remove PHA from the PHA-containing biomass.

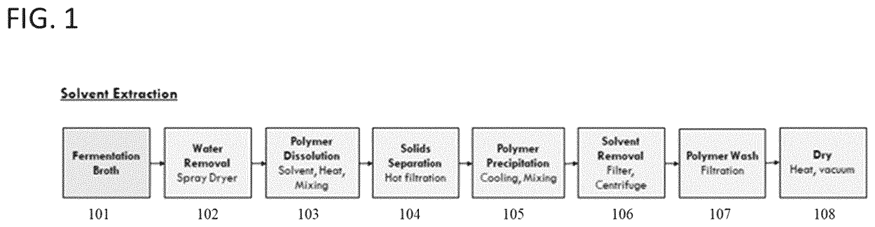

FIG. 1 illustrates a flowchart of an non-limiting process for solvent extraction of PHA from microbial biomass.

Traditionally, the separation of biomass from liquid growth media is difficult and impractical due to the plugging and fouling characteristics of biomass. In several embodiments, a method enabling the efficient filtration of microorganisms is provided. In some embodiments, a liquid chemical is added to the growth media comprising microorganisms, wherein the liquid chemical is ethanol, acetone, methanol, methylene chloride, ketones, alcohols, and/or chlorinated solvents, or a combination thereof. In some embodiments, microorganisms are then efficiently separated from liquid growth media using standard filtration equipment, such as a Buchner filter, filter press, or similar apparatus. In one embodiment, approximately 2 parts acetone are mixed with one part water, including both intracellular and extracellular water, to effect the efficient filtration of microorganisms comprising the water. In some embodiments, microorganisms in a fermentation broth (e.g., a fermentation broth comprising a population of PHA-producing microorganisms) are lysed, resulting in release of PHA into the mixture. The mixture is then filtered in order to separate the PHA from the smaller fragments of lysed biomass. In addition, a caustic purification step is often required prior to separation of PHA from the purification solution. The pH of the separated PHA must then be adjusted so that the separated PHA may be polished, dewatered, and further processed into a final dried PHA product. However, aqueous extraction can be resource intensive, in particular in terms of water usage. In several embodiments, therefore, alternative approaches are provided for.

### Dehydration of PHA-Containing Biomass.

In several embodiments, a fermentation broth 101 is provided or otherwise collected (e.g., from a culture vessel or bioreactor). In several embodiments the culture vessel or bioreactor is a sleeved/jacketed vessel. In several embodiments, the fermentation broth comprises a plurality of microorganisms that have metabolized a carbon source to produce one or more types of PHA. In several embodiments, the fermentation broth 109 is subjected to one or more steps for water removal 109 from the broth. In several embodiments, a spray dryer is used for water removal 110. In several embodiments Nutsche filter/dryers are used for water removal. Other alternative methods for water removal are known in the art, e.g., centrifugation, gas (e.g., nitrogen). In several embodiments, compression is used to assist with water removal. Post water removal, there remains a biomass powder comprising between about 30% to about 70% (e.g., ˜50%) PHA by mass.

### Polymer Dissolution

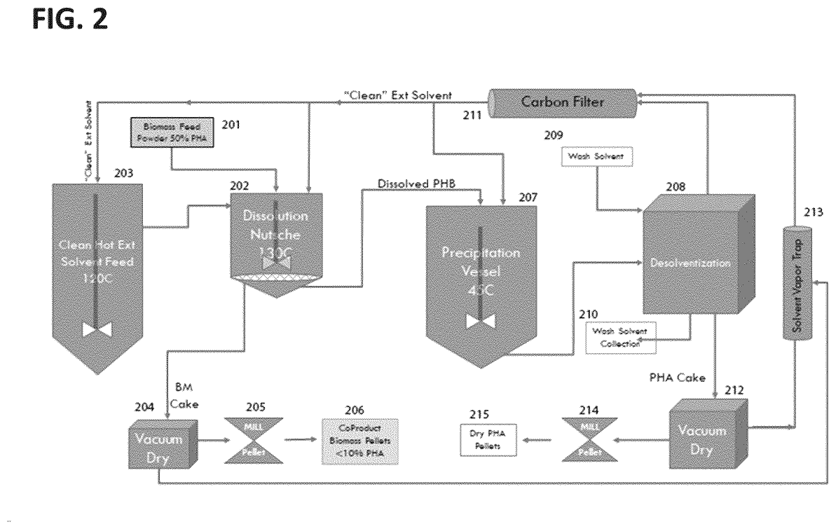

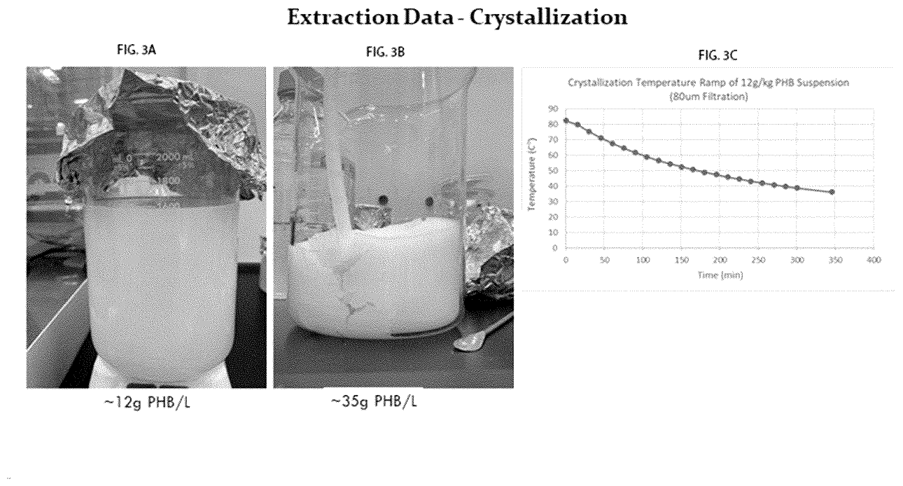

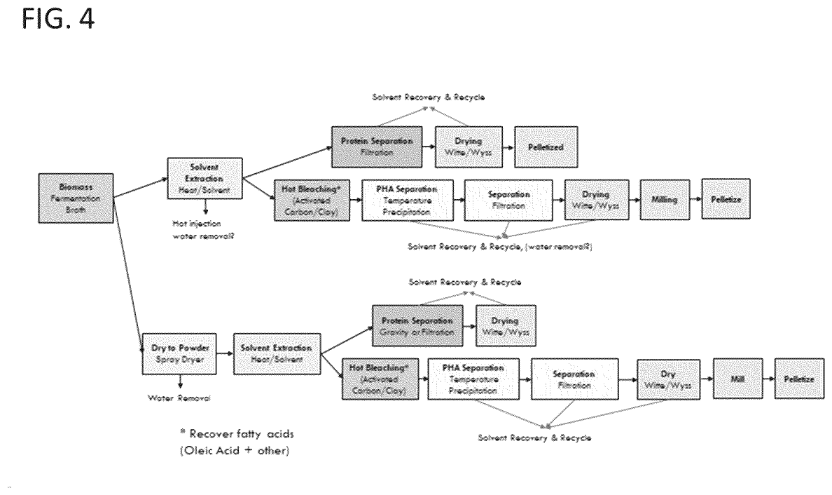

This biomass powder (see 201 in FIG. 2) is then subject to dissolution 103 in order to dissolve the PHA polymer for subsequent processing. In several embodiments, as discussed in more detail below, uses a combination of solvent, heat and mid- to high-shear mixing to dissolve the polymer. In several embodiments, a solvent-based extraction system is utilized to carry out PHA extraction. In some embodiments, solvents are utilized to carry out PHA extraction at high temperatures, wherein PHA extraction occurs simultaneous with a temperature-enhanced breakdown or dissolution of PHA-containing biomass. In some embodiments, one or more solvent is utilized that is biodegradable and metabolically assimilable by the culture, such that PHA-reduced biomass comprising biomass and one or more biodegradable solvent may be contacted with the culture, and both the PHA-reduced biomass and the solvent may be utilized by the culture as a source of carbon. Non-limiting examples of such solvents include carbon dioxide, acetone, ethanol, and methanol, among others. In a preferred embodiment the solvent is butyl acetate.

In several embodiments a mixture of solvent and PHA comprises multiple phases, e.g., an aqueous phase and an organic phase. In some embodiments, solvent-based extraction comprises a more uniform mixture of solvent and PHA. In some embodiments, depending on the solvent, the phases are separated prior to recovery of the PHA. In some embodiments, centrifugation is employed to further distinguish and separate the phases of the mixture (e.g., separation of the solvent-PHA phase from the water-biomass phase). In some embodiments, heat is also employed to maintain the solubility of the PHA in a given solvent.

It will be appreciated that the solubility of PHA varies with the solvent used, and therefore the temperature (if adjusted) and the separation techniques are tailored to match the characteristics of a given solvent. Thus, in some embodiments centrifugation is used to separate the solvent-PHA phase from the water-biomass phase. In some embodiments, depending on the solvent, higher speed centrifugation is used. In some embodiments, centrifugation is employed in stages, e.g., low speed centrifugation followed by high speed centrifugation. Any of a variety of centrifuges can be employed, depending on the solvent used, for example, basket centrifuges, swinging bucket centrifuges, fixed rotor centrifuges, disc-back centrifuges, supercentrifuges, or ultracentrifuges.

A hot filtration process (which can either be done in a batch, semi-batch, or continuous process) is used for solids separation 104, which separates the residual biomass from the dissolved polymer. In several embodiments the hot filtration is performed in a jacketed and/or sleeved vessel. In several embodiments the dissolution vessel is a Nutsche filter dryer. During the hot filtration, the biomass powder is subjected to relatively hot solvent and high shear agitation using, for example, an immersion blender. In several embodiments the solvent is preheated in an external vessel. In some embodiments hot solvent in said external vessel is agitated, e.g., mixed, to maintain an uniform temperature, e.g., between about 110 degrees and 130 degrees (e.g., about 120 degrees) Celsius. In the dissolution vessel, high shear agitation (e.g., immersion blender or paddle mixer, or other mixing device) and heat is applied to the PHA-containing biomass for between about 3 hours and 7 hours (e.g., about 5 hours) which results in isolation of a PHA-rich solvent phase and a PHA-lean biomass phase. The PHA is isolated from the PHA-lean biomass by forcing, e.g., pressure, vacuum, the biomass solids through a filter. In some embodiments the biomass solids are optionally compressed to remove residual solvent. In some embodiments residual solvent is optionally removed from the biomass cake, by use of a gas, e.g., nitrogen. In some embodiments, the biomass cake is further dried and processed, e.g., milled, or pelleted (see, e.g., 204-206 in FIG. 2). In some embodiments, adjustable discharge ports suitable for a particular centrifuge are used in order to control the rate and degree of separation of solvent-PHA phase from the water-biomass phase. In some embodiments, the concentration of water in the water-biomass phase is adjusted to allow for suitable flow of the mixture through the centrifuge (or within a centrifuge tube). For example, in some embodiments, flow is suitable for separating the phases when the concentration of biomass (relative to water) is between about 1 and 100 g/L. In some embodiments, the concentration is between about 10 to 20 g/L, 20 to 30 g/L, 30 to 40 g/L, 40 to 50 g/L, 50 to 60 g/L, 60 to 70 g/L, 70 to 80 g/L, 80 to 90 g/L, 90 to 100 g/L, 100 to 200 g/L, 200 to 400 g/L, 400 to 600 g/L, and overlapping ranges thereof. In some embodiments, both centrifugation and filtration are used in combination (e.g., sequentially). In some embodiments, centrifugation is optionally followed by filtration. In other embodiments, filtration is optionally followed by centrifugation. Filtration, in some embodiments is performed under vacuum pressure, via gravity feed, under positive pressure, or in specialized filtration centrifuges. In some embodiments, the filter pore size is adjusted based on the species composition of the microorganism culture. In some embodiments, pore sizes of up to 200 μm are used. In some embodiments, smaller pore sizes are used, for example 15 to 20 μm, 10 to 15 μm, 5 to 10 μm, 1 to 5 μm, 0.001 to 1 μm, and overlapping ranges thereof.

### Polymer Precipitation

According to several embodiments, dissolved polymer is then precipitated 105, (for example in a jacketed/sleeved vessel). The PHA-rich solvent is subjected to reductions in temperature, e.g., between about 30 degrees and about 60 degrees (e.g., about 45 degrees) Celsius, and low-shear mixing, resulting in PHA polymer precipitation from the solution. In some embodiments the PHA-rich solvent is forced, e.g., pressure or vacuum, automatically, or manually, into the precipitation vessel. In some embodiments dissolution and precipitation of the PHA can occur in the same vessel. In some embodiments the precipitation vessel is pressurized. In some embodiments the precipitation vessel is a Nutsche filter dryer. In some embodiments heat is added or removed to maintain a constant temperature. In some embodiments cooler recycled solvent is added to reduce the temperature of the PHA-rich solvent and promote precipitation. In several embodiments, a combination of methods, e.g., heat addition, agitation, solvent addition, are used to cool the PHA-rich solvent at a specific rate. In several embodiments the cooling rate of the PHA-rich solvent is chosen for its suitability to precipitate PHA crystals of a desired size. In several embodiments the specific cooling rate depends on the identity of the chosen solvent.

### Desolventization

Precipitated PHA is subject to filtration, centrifugation or other means, for example in a jacketed, or sleeved vessel, for solvent removal at 106. In some embodiments the desolventization vessel is a Nutsche filter dryer. In some embodiment the desolventization vessel is separate from the precipitation vessel. In some embodiments, precipitation and desolventization of the PHA occur in the same vessel. Wash solvent (e.g., ethanol or other solvent having a lower boiling point than the initial dissolution solvent) is then used for a polymer wash step 107 followed by filtration. In some embodiments, the dissolution vessel is pressurized. In some embodiments the pressure of the dissolution is such that the wash solvent can be maintained in a fluid state at temperatures higher than its boiling point. In some embodiments the resultant PHA cake can be optionally compressed to remove cracks from the PHA cake and assist with removal of residual solvent. In some embodiments, gas, e.g., nitrogen, may be used to assist with removal of residual solvent. In some embodiments the wash solvent is recovered, for example in a jacketed, or sleeved vessel (see 210 in FIG. 2). In some embodiments the recovered wash solvent is filtered and reused in further PHA extraction processes. In some embodiments the wash solvent is derived from microbes. In a preferred embodiment, the wash solvent is ethanol.

In addition to the steps outlined above, additional steps may optionally be taken to remove solvent from the extracted PHA, including evaporation, solvent casting, steam stripping, heat treatment, and vacuum treatment, each of which may be preferential, cost-effective, time-effective, or advantageous depending on the volatility and type of solvent used. In other embodiments, active processes can be used to reduce the solvent content of the solvent-PHA mixture. For example, in certain embodiments, alterations in temperature of certain solvents change the solubility of the PHA in the solvent, which effectively removes solvent from the PHA (e.g., the solvent is now separable from a precipitated PHA). In some embodiments, filtration, solvent temperatures, or vacuum treatment can be increased to reduce a portion of the solvent. In some embodiments, solvent to PHA ratios post extraction, filtration, evaporation, solvent casting, steam stripping, heat treatment, and/or vacuum treatment range from about 0.1:1 to about 1,000:1, including about 0.2:1, 0.3:1, 4.0:1, 5.0:1, 10.0:1, 20.0:1, 60:1, 70:1, 80:1, 90:1, 100:1, 200:1, 500:1, and 900:1.

As a result of the processes disclosed above, in some embodiments, the solvent is substantially removed from the isolated PHA in the PHA-rich solvent phase and the liquid is substantially removed from the PHA-reduced biomass in the PHA-lean liquid phase. In some embodiments, the isolated PHA is dried in a heated vessel to produce substantially pure isolated PHA (e.g., at least 80% PHA by dry weight, preferably at least 98% PHA by weight, more preferably at least 99% PHA by weight). The terms “isolated PHA” and “substantially isolated PHA” have their ordinary meanings, including, among other things, PHA that has been removed from a biomass material as a result of an extraction process, or a biomass material wherein the concentration of PHA relative to non-PHA material has been increased by an extraction process. In several embodiments, isolated PHA is further treated in one or more of a variety of ways, including, but not limited to, purification, filtration, washing, oxidation, odor removal, pigment removal, lipid removal, non-PHA material removal, and/or drying, including centrifugation, filtration, spray drying, freeze drying, simple or fractional distillation, or density differentiation. Methods for the purification of PHA include the use of peroxides, water, hypochlorite, solvents, ketones, alcohols, and various other agents to separate and remove non-PHA material from PHA material.

### Drying of Resultant PHA

The resultant PHA is subjected to drying 108 using increased temperatures and under vacuum. The resultant clean and dry PHA can then be milled or pelleted to yield a final PHA product (see 215 in FIG. 2).

Numerous varieties of heated or drying vessels may be used to dry the isolated PHA, including ovens, centrifugal dryers, air dryers, spray dryers, and freeze dryers, among others. In some embodiments, heat is applied to a drying vessel to speed the process and/or to remove (e.g., evaporate traces of solvent from the PHA). It shall be appreciated that the moisture content of the isolated PHA will depend, in some embodiments, on the solvent used, and the corresponding separation technique used (as described above). For example, a volatile solvent in combination with ultracentrifugation would result in a less moist extracted PHA, while a less active separation technique (e.g., gravity phase separation) would yield a more moist extracted PHA. In some embodiments, internal dryer temperatures range from 20° C. to 40° C. to about 200° C. In some embodiments, internal temperatures range from about 50° C. to 90° C., about 90° C. to 180ºC, about 65° C. to 175° C. and overlapping ranges thereof. In some embodiments, outlet temperatures are substantially lower than inlet on internal temperatures. In some embodiments, outlet temperatures range from 30° C. to 90° C. In some embodiments, outlet temperatures are between about 35° C. to 40° C., about 40° C. to 45° C., about 45° C. to 50° C., about 50° C. to 55° C., about 55° C. to 90° C., and overlapping ranges thereof. It shall also be appreciated that the internal and outlet temperatures may be adjusted throughout the drying process (e.g., the temperature difference may initially be large, but decrease over time, or vice versa).

From the above discussion, it will be appreciated that the type of dryer used, and the temperatures used (if other than atmospheric temperatures) are easily tailored to correspond to the techniques used in the extraction process. In some embodiments, particular dryer components are beneficial in the isolation of PHA. For example, depending on the moisture content of the extracted PHA (e.g., the amount of residual solvent) particular components of an evaporative-type dryer, such as an oven dryer, rotary dryer, spin flash dryer, spray dryer (equipped with various types of nozzle types, including rotary atomizer, single flow atomizer, mist atomizer, pressure atomizer, dual-flow atomizer) convection heat dryer, tray dryer, scrape-flash dryer, or other dryer type are used. By way of additional example, if a freeze dryer (e.g., a lyophilizer) is used, in some embodiments a manifold dryer is used, optionally in conjunction with a heat source. Also by way of example, a tray lyophilizer can be used, in some embodiments, with the isolated and dried PHA being stored and sealed in containers (e.g., vials) before re-exposure to the atmosphere. In certain embodiments, such an approach is used when long-term storage of the PHA is desired.

It will also be appreciated that certain varieties of heated/drying apparatuses have adjustable flow rates that can be tailored to the moisture content of the isolated PHA. For example, an isolated PHA having a high moisture content would be fed into a dryer at a slower input rate to allow a higher degree of drying per unit of PHA inputted into the dryer. Conversely, a low moisture content isolated PHA would likely require less time to dry, and therefore could be input at a faster rate. In some embodiments, input rates of isolated PHA range from several hundred liters of isolated PHA-solvent mixture per minute down to several milliliters per minute. For example, input rates can range from about 10 mL/min to about 6 L/min, including about 10 ml/min to about 50 ml/min, about 50 mL/min to about 100 ml/min, about 100 ml/min to about 500 ml/min, about 500 ml/min to about 1 L/min, about 1 L/min to about 2 L/min, about 2 L/min to about 4 L/min, about 4 L/min to about 6 L/min, and about 100 L/min to about 500 L/min.

### Recovery and Cleaning of Used Solvent

As will be appreciated from the above discussion, in some embodiments solvent can be lost at various stages of the PHA extraction process, including during, among other things, drying of the PHA-lean biomass cake, precipitation of the PHA from the PHA-lean solvent, and drying of the isolated PHA cake. It will also be appreciated that the PHA-lean solvent can be in multiple states (e.g., fluid, vapor) depending on the nature of the process and specific means chosen at any particular stage. For instance, vacuum drying, centrifugating, evaporation may produce PHA-lean solvent in vapor or fluid form, among other things. It is therefore one aspect of the present invention that the PHA-lean solvent is trapped or otherwise recovered at the various stages of the disclosed PHA extraction process. In some embodiment the PHA-lean solvent is a vapor that is trapped and distilled. In some embodiments the PHA-lean solvent is a fluid that is contained in a vessel or closed plumbing system. Unwanted impurities are then filtered from the recovered PHA-lean solvent. In some embodiments the filter is an activated carbon charcoal filter. In some embodiments, the clean solvent is transferred to an external storage tank. In some embodiments, the clean solvent is returned to the system for use in further batch and/or continuous implementations of the disclosed process. In some embodiments, the recycled solvent is brought to a uniform temperature with the solvent mixed with the solvent in the vessel it is returned to.

### Example 1

It will be appreciated that not necessarily all objects or advantages may be achieved in accordance with any particular embodiment described in this example. Thus, for example, those skilled in the art will recognize that certain embodiments may be configured to operate in a manner that achieves or optimizes one advantage or group of advantages as taught herein without necessarily achieving other objects or advantages as may be taught or suggested herein.

FIG. 2 illustrates a schematic diagram of one example system that enables the renewable extraction of PHA from biomass according to some embodiments herein. In some embodiments, clean solvent, e.g., butyl acetate, is heated (for example in a jacketed/sleeved vessel) and held at between about 110 and about 130 (e.g., about 120) degrees Celsius. In some embodiments, recycled solvent is returned to the vessel and additional heat input is applied to account for the decrease in temperature due to cooler recycled solvent. The hot solvent is optionally subject to mixing (e.g., stirring) for uniform temperature. The clean solvent is fed into the dissolution Nutsche 202 along with biomass feed powder with approximately 50% PHA content. The clean solvent can be fed in a batch or semi batch basis. The clean solvent can be force fed, e.g., pressure, or vacuum, automatically, or manually. The biomass feed powder can be added in a batch basis or semi-batch basis. Biomass can be fed from a hopper, e.g., automatically, or manually. The dissolution Nutsche is equipped with one or more filters, e.g., cloth, single layer metal screen, or multi-layered sintered metal. In several embodiments, the filter pore size is chosen for its suitability in separating PHA crystals of a desired size. In some embodiments, the filters have pore sizes between about 0.01 and about 200 (e.g., about 150) μm. In some embodiments, the filters have pore sizes greater than 200 μm. Additional heat input is applied to the dissolution Nutsche to increase and hold the temperature of the dissolution media comprising the clean solvent and biomass at between approximately 120 and about 140 (e.g., about 130) degrees Celsius. The dissolution Nutsche can optionally be pressurized to prevent evaporation of the solvent at temperature. The heated dissolution media is then subjected to high shear mixing for between about 3 and about 7 (e.g., about 5) hours to dissolve and isolate the PHA from the Biomass solids. Shear mixing is accomplished by, for example, an immersion blender. PHA-lean biomass solids are forced, e.g., pressure, or vacuum, through the filter in the dissolution Nutsche, forming a PHA-lean biomass cake. The biomass cake is then evacuated from the dissolution Nutsche to a dryer 204, e.g., a vacuum dryer. The biomass cake is then optionally subjected to drying using increased temperatures and vacuum. The PHA-lean solvent vapors released during drying of the biomass cake are recovered using a solvent vapor trap 213. The trapped vapor is filtered using a filter 211, e.g., an activated carbon filter, to remove unwanted impurities. In some embodiments, the trapped solvent vapors are optionally condensed prior to filtration. In some embodiments, the solvent vapors are condensed following filtration. In some embodiments, the recycled solvent is returned to the solvent vessel 203. In some embodiments, the recycled solvent is returned to the dissolution Nutsche and additional heat input is applied to account for the decrease in temperature due to cooler recycled solvent. The solvent returned to the dissolution Nutsche is heated to an equilibrium temperature, e.g., approximately 130 degrees, through mixing, e.g., high shear agitation. Additional heat may be applied to the vessel to maintain temperature due to the cooler recycled solvent. The resultant dried biomass cake is then optionally be milled and pelleted 205 into biomass pellets containing less than approximately 10% PHA 206.

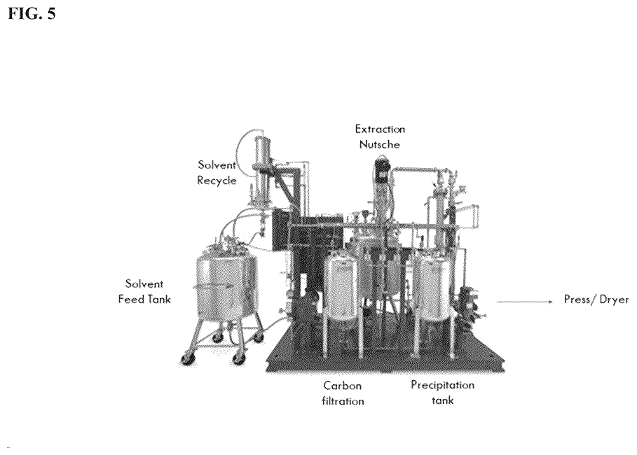

Returning to the output of the dissolution Nutsche 202, PHA-rich solvent is transported to a precipitation vessel and cooled (for example in a jacketed/sleeved vessel) and held at between approximately 30 and approximately 60 (e.g., approximately 45) degrees Celsius. The PHA-rich solvent is subjected to mixing, e.g., low shear agitation, during cooling to achieve uniform cooling of the mixture. The cooling rate of the PHA may optionally be varied to precipitate PHA crystals of a desired size, for example PHA crystals less than about 50 μm, between about 50 μm and about 150 μm, e.g., about 80 μm, or greater than 150 μm. The precipitation vessel may optionally be a second Nutsche. The precipitation vessel may be heated or cooled as necessary to maintain hold the temperature of the precipitation vessel steady, e.g., at approximately 45 degrees. The extracted PHA is then desolventized (for example in a jacketed/sleeved vessel) by washing the PHA with a second solvent, e.g., a wash solvent. The wash solvent, e.g., ethanol, is fed (for example in a jacketed/sleeved vessel) through the desolventization vessel 208 and collected 210 (for example in a jacketed/sleeved vessel). The wash solvent is optionally filtered and reused. In some embodiments the desolventization vessel is a Nutsche. In some embodiments precipitation and desolventization occur in the same vessel. The desolventization vessel may optionally be pressurized to allow heating of the wash solvent above the solvents boiling point. Heat mat be added or removed from the desolventization vessel to hold the temperature at a desired temperature. The PHA-lean solvent removed from the isolated PHA during desolventization is captured and filtered, e.g., an activated carbon filter 211. In some embodiments, recycled solvent is returned to the solvent vessel 203 and additional heat input is applied to account for the decrease in temperature due to cooler recycled solvent. The hot solvent is optionally subject to mixing (e.g., stirring) for uniform temperature. In some embodiments, recycled solvent is returned to the dissolution Nutsche 202 and additional heat input is applied to account for the decrease in temperature due to cooler recycled solvent. PHA cake is evacuated from the desolventization vessel to a second dryer, e.g., a second vacuum dryer 212. The PHA cake is subjected to drying using heat under vacuum. Residual solvent, e.g., solvent vapors, are trapped 213, e.g., a solvent vapor trap, and filtered, e.g., an activated carbon filter 211. In some embodiments, recycled solvent is returned to the solvent vessel 203 and additional heat input is applied to account for the decrease in temperature due to cooler recycled solvent. The hot solvent is optionally subject to mixing (e.g., stirring) for uniform temperature. In some embodiments, recycled solvent is returned to the dissolution Nutsche 202 and additional heat input is applied to account for the decrease in temperature due to cooler recycled solvent. Dried PHA cake may optionally be smoothed, e.g., using gas, to close cracks and further reduce the moisture level. The resultant clean and dry PHA can then be milled or pelleted 214 to yield a final PHA product 215. In some embodiments, the vessels used for extraction of PHA from biomass are connected together in a closed system (see FIG. 5).

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein. Overall, the language of the claims is to be interpreted broadly based on the language employed in the claims. The claims are not to be limited to the non-exclusive embodiments and examples that are illustrated and described in this disclosure, or that are discussed during the prosecution of the application.

Those skilled in the art will also appreciate that in some embodiments the functionality provided by the components, structures, methods and processes discussed above may be provided in alternative ways, such as being split among more components or methods or consolidated into fewer components or methods. In addition, while various methods may be illustrated as being performed in a particular order, those skilled in the art will appreciate that in other embodiments the methods may be performed in other orders and in other manners.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of a renewable and sustainable process for extraction of PHA from microbial biomass have been disclosed. Although the systems, techniques, and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. A renewable and sustainable process for extraction of PHA from microbial biomass, the renewable and sustainable process comprising:
(a) delivering PHA containing biomass to a dissolution vessel;
(b) contacting said PHA containing biomass with an external solvent to generate PHA-rich solvent and PHA-reduced biomass;
(c) substantially isolating the PHA-rich solvent from the PHA-reduced biomass;
(d) precipitating PHA contained in the PHA-rich solvent to generate precipitated PHA;
(c) isolating precipitated PHA from the PHA-rich solvent to generate isolated PHA;
(f) drying the isolated PHA; and
(g) processing the isolated PHA.

2. The renewable and sustainable process of claim 1, wherein the PHA comprises one or more PHA polymers selected from Polyhydroxyalkanoate (PHA), polyhydroxybutyrate (PHB), polyhydroxyvalerate (PHV), polyhydroxybutyrate-covalerate (PHB/V), polyhydroxyhexanoate (PHHx), short chain length (SCL) PHA, medium chain length (MCL) PHA, and long chain length (LCL) PHA.

3. The renewable and sustainable process of claim 1, wherein the external solvent is a halogenated solvent or a non-halogenated solvent.

4. (canceled)

5. The renewable and sustainable process of claim 1, wherein the PHA-rich solvent comprises one or more of Butyl acetate, isobutyl acetate, ethyl lactate, isoamyl acetate, benzyl acetate, 2-methoxy ethyl acetate, tetrahydrofurfuryl acetate, propyl propionate, butyl propionate, pentyl propionate, butyl butyrate, isobutyl isobutyrate, ethyl butyrate, ethyl valerate, methyl valerate, benzyl benzoate, methyl benzoate, dimethyl succinate, dimethyl glutarate, dimethyl adipate, isobutyl alcohol, 1-butanol, 2-methyl-1-butanol, 3-methyl-1 butanol, 1-pentanol, 3-pentanol, amyl alcohol, allyl alcohol, hexanol, heptanol, octanol, cyclohexanol, 2-ethylhexanol, tetrahydrofurfuryl alcohol, furfuryl alcohol, benzyl alcohol, 2-furaldehyde, methyl isobutyl ketone, methyl ethyl ketone, g-butyrolactone, methyl n-amyl ketone, 5-methyl-2-hexanone, ethyl benzene, 1,3-dimethoxybenzene, cumene, benzaldehyde, 1,2-propanediol, 1,2-diaminopropane, ethylene glycol diethyl ether, 1,2,3-trimethylbenzene, 1,2,4-trimethylbenzene, 1,3-dioxane, 1,4-dioxane, 1-nitropropane, toluene-2,4-diisocyanate, acetic acid, acrylic acid, acetic anhydride, alpha-methylstyrene, acetophenone, toluene, ethylene glycol diacetate, dimethyl sulfoxide, dimethyl acetamide, dimethyl formamide and propylene carbonate.

6. The renewable and sustainable process of claim 5, wherein the PHA-rich solvent comprises butyl acetate.

7. The renewable and sustainable process of claim 1, wherein the PHA-rich solvent is naturally produced and/or is heated.

8. (canceled)

9. The renewable and sustainable process of claim 1, wherein dissolution of PHA and PHA containing biomass comprises subjecting the PHA and PHA containing biomass to relatively higher temperatures.

10. The renewable and sustainable process of claim 1, wherein dissolution of PHA and PHA containing biomass comprises agitation of the PHA-rich solvent and PHA containing biomass and/or wherein the dissolution of PHA and PHA containing biomass comprises low shear agitation.

11. (canceled)

12. The renewable and sustainable process of claim 1, wherein dissolution of PHA and PHA containing biomass occurs over 0-5 hours, 1 hour, 2 hours, 3 hours, 4 hours, or 5 hours.

13. (canceled)

14. The renewable and sustainable process of claim 1, wherein the dissolution vessel comprises an internal filter.

15. The renewable and sustainable process of claim 14,
wherein the internal filter is a Nutsche style filter.

16. The renewable and sustainable process of claim 1, further comprising separation of the PHA-reduced biomass from the PHA-rich solvent by centrifugation or by filtration.

17. (canceled)

18. The renewable and sustainable process of claim 1, wherein the PHA-reduced biomass comprises less than 10%, 9%, 8%, 7%, 6%, 5%, 4%, 3%, 2%, 1%, 0.1% PHA.

19. The renewable and sustainable process of claim 16, wherein the internal filter comprises pore sizes of up to 200 μm, 190 μm, 180 μm, 170 μm, 160 μm, 150 μm, 150-100 μm, 100-50 μm, 50-20 μm, 20-15 μm, 15-10 μm, 5-10 μm, 1-5 μm, 1-0.001 μm, and overlapping ranges thereof.

20. The renewable and sustainable process of claim 1, further comprising drying of the PHA-reduced biomass separated from the PHA-rich solvent.

21. The renewable and sustainable process of claim 20, wherein the PHA-reduced biomass is dried by vacuum, evaporative-type dryer, oven dryer, rotary dryer, spin flash dryer, spray dryer convection heat dryer, tray dryer, scrape-flash dryer, or other dryer type.

22. The renewable and sustainable process of claim 20, wherein residual solvent vapor released from the PHA-reduced biomass during drying is trapped.

23. The renewable and sustainable process of claim 22, further comprising filtration of the residual solvent vapor.

24. The renewable and sustainable process of claim 23, wherein the internal filter comprises an activated carbon filter.

25. The renewable and sustainable process of claim 1, further comprising returning the external solvent to at least one of an external solvent storage tank, the dissolution vessel, or to a precipitation vessel.

26. (canceled)

27. (canceled)

28. The renewable and sustainable process of claim 20, further comprising milling and/or pelleting of the PHA-reduced biomass.

29. The renewable and sustainable process of claim 20, wherein the dried-PHA-reduced biomass is re-fed into the renewable and sustainable process for further extraction of PHA.

30-54. (canceled)

55. The renewable and sustainable process of claim 1, further comprising milling and/or pelleting of the isolated PHA.

56. The renewable and sustainable process of claim 1, wherein the PHA containing biomass is derived from methanotrophic microorganisms.
